(19) United States
(12) Patent Application Publication
(10) Pub. No.: US 2023/0186222 A1
(43) Pub. Date: Jun. 15, 2023

(54) PRODUCTION DEFECT AND ABNORMALITY REPORT AND TRACK RECORD RETRIEVAL SYSTEM FOR THE TEXTILE INDUSTRY

(71) Applicant: I-MIN LIN, TAINAN (TW)

(72) Inventor: I-MIN LIN, TAINAN (TW)

(73) Assignee: TUNTEX INCORPORATION, KAOHSIUNG (TW)

(21) Appl. No.: 17/552,280

(22) Filed: Dec. 15, 2021

(51) Int. Cl. G06Q 10/06; G06Q 50/04; G05B 19/418

(52) U.S. Cl. CPC G06Q 10/06395; G06Q 50/04; G06Q 10/0633; G05B 19/41875; G05B 2219/32368

(57) ABSTRACT

The present utility model discloses a production defect and abnormality report and track record retrieval system for the textile industry, which is made up of a textile machine, an information appliance, a server host, and a production track record retrieval platform in the server host can collect, store, integrate, and submit the data in real time, so that the production track record of finished textile products can be retrieved through the production track record retrieval platform, and through the production track record retrieval platform, the user can review the whole production history and defect analysis remotely. Therefore, the production defect and abnormality report and track record retrieval system for the textile industry can significantly enhance work efficiency, reduce defect rate, and enables quick retrieval and transparency of the production track record.

### BACKGROUND OF INVENTION

### 1. Field of the Invention

The present utility model relates generally to a production information retrieval system for the textile industry, and more particularly to a production defect and abnormality report and track record retrieval system for the textile industry made up of a textile machine, an information appliance, a server host and a production track record retrieval platform connected and integrated together for quick report and remote query.

### 2. Description of Related Art

Driven by the rapid development of science and technology and the tremendous growth of the information industry, the textile industry is undergoing constant upgrading of production process, production technique, sales and marketing, management, networking, etc. through technological innovations. Over the recent years, the concept of the Internet of Things (IOT) is increasingly influencing modern life, or even the manufacturing industry. The Internet of Things applied in industries is generally called Industrial Internet of Things (IIoT), which focuses on machine-to-machine communication. Through such technologies as big data, artificial intelligence, and cloud computing, industrial operations become more efficient and reliable. The highly efficient IoT can improve human-machine interaction, enhance data management and analysis, as well as the efficiency of data transformation into useful information for better decision making.

Over the recent years, intelligent manufacturing and IoT technologies are increasingly introduced into the textile industry. However, the integration of IoT into the textile industry is still facing a big problem. Lack of a general standard leads to low compatibility between different platforms. Also, due to the wide variety of IoT appliances, it is very difficult to cope with the difference between existing hardware and newly developed software. Moreover, to embrace intelligent manufacturing, the textile industry must improve remote monitoring technologies. Remote monitoring in intelligent manufacturing allows manufacturers to keep track of the machine status and production progress in real time, and to adjust manufacturing schedules at any time, thus reducing possibilities of machine shutdown or failure and significantly improving efficiency and duration of the manufacturing facility. Also, consumers can have more transparent and traceable production information and be aware of the related manufacturing processes.

At present, product manufacturing in the textile industry is greatly different from the past. In the past, it was difficult to retrieve the internal production track record of the textile factory. The demand of customers for production track record cannot be satisfied. When customers buy the products they need, they have no way to understand the whole production process of the product and the status of the manufacturer. However, currently, it is becoming more and more important for international big-name companies to keep track of the production. They frequently require remote query of the production track record or related defect reports of their products.

In the process of intelligent manufacturing, production abnormality tracking and production track record are very important factors in quality control and product after-sale management. They can help monitor the production, automatically correct or improve the operations, report machine or system abnormality, and carry out real-time troubleshooting to reduce the possibility of failure as well as the production line downtime. Comparative analysis can be made between the actual operations, the history and the expected result, and the cause of production abnormality can be identified. The production track record, the reason of product defect or production abnormality, as well as the process of analysis made by the factory people can be provided to the consumer or the customer. Therefore, it is an important and imperative task for textile manufacturers to find solutions for efficient integration between upstream and downstream manufacturing facilities, real-time detection of production defects to improve quality and reduce production cost, and quick production track of customer's product. Such solutions will contribute to better management and troubleshooting efficiency, real-time report and removal of defect and abnormality, and more transparent product information for consumers who can have a clear track record of the whole production process of the product.

Along with the rapid development of information technology and industrial automation, governments are also constantly promoting reforms in connection with the application of information technology and Industry 4.0 solutions. Many industries are gradually advancing toward automatic production. The early stage of industrial development in our country was dominated by traditional labor-intensive and export-oriented manufacturing. The efficiency was low. In order to be more competitive in the global market, many industries are seeking to introduce automated production, and the traditional textile industry is no exception. However, in actual practice, it is found that many programs are incompatible. Not only machine networking is difficult, the networking between production process and human resource management is also difficult. As a result, there is always some degree of deficiency in production processes or management systems. When it comes to automated production in the textile industry, the processes cannot be streamlined, or the production abnormalities cannot be monitored and handled in real time. Such problems lead to delay and defect. Therefore, it is imperative for manufacturers to find solutions to effectively integrate the upstream and downstream production processes, reduce production cost and waste, and meanwhile enhance management efficiency, so that the whole production can be carried out automatically with real-time defect and abnormality detection and analysis.

### SUMMARY OF THE INVENTION

In view of the above technical problems, the inventor has made great efforts in research and development based on years of experience in creative invention, and has developed the present utility model after repeated corrections and improvements to enhance the advantages of the present utility model and overcome the disadvantages of the prior art.

The main object of the present utility model is to establish a database to enable retrieval of production abnormality track record, so that all information about the cloth item can be reported and recorded in the system in real time from material acquisition, production to delivery, for example, abnormal setup during production, abnormality during inspection, machine failure, repair time, etc.

Another object of the present utility model is to provide a basis to facilitate query of the production track record by customers, for example, to provide a query interface to input Item No., Lot No., Color, Process, Defect Type, Order No., etc. to retrieve the whole track record, so that the complete history and quality record can be tracked.

In order to achieve the above objects, the production defect and abnormality report and track record retrieval system for the textile industry disclosed in the present utility model is made up of a textile machine, an information appliance, a server host and a production track record retrieval platform. The textile machine is equipped with at least one production status detector. The production status detector can detect the production status information of the textile machine. The information appliance includes an order confirmation management system for real-time input and generation of production work order, machine work order and process work order, and includes a data collection system, a cloud database, a production defect and abnormality data collection system, a production defect and abnormality report system and a production track record retrieval system, wherein, the data collection system includes a textile machine production data collection module and a production order confirmation data collection module. The textile machine production data collection module is connected to the textile machine, so that the production status information of the textile machine can be processed by the textile machine production data collection module and transmitted to the cloud database. The production order confirmation data module is connected to the information system, so that the production work orders and process work orders in the information system can be processed by the production order confirmation data module and transmitted to the cloud database. The production defect and abnormality data collection system is connected to the cloud database, and includes a production abnormality track record module and a machine failure management module. The production abnormality track record module is mainly used for collecting production abnormality data, and includes an abnormal behavior setup program, an abnormality data collection program, an Item No., Lot No. and Order No. integration program and a finished product inspection abnormality information integration program. The machine failure management module is mainly used for collecting machine failure data, and includes a downtime management program and repair time management program. The production defect and abnormality report system is connected to the cloud server and includes a production defect report module and a machine failure report module. After the production abnormality track record module has collected the production abnormality data, the data will undergo intelligent computing by the production defect report module and be transmitted to a terminal device. After the machine failure management module has collected the machine failure data, the data will undergo intelligent computing by the machine failure report module and be transmitted to a terminal device. The production track record retrieval system is connected to the cloud server and includes a production track record query module and a machine failure query module. The production track record query module integrates the data from the textile machine production data collection module and production abnormality track record module and generates a production track record. The machine failure query module integrates the data from the production order confirmation data collection module and machine failure management module and generates a machine failure information track record. The production track record retrieval platform is connected to the server host, and includes a production track record retrieval module. The user can use the production track record retrieval module to input Item No., Lot No., Color, Process, Defect Type or Order No. to the cloud database and retrieve the production track record and machine failure information track record. Based on this, the manufacturer can effectively track the production abnormality status. Through data collection, abnormality data integration and abnormality data notification, a defect and abnormality report can be generated and the data can be integrated for analysis. Also, consumers can use the production track record retrieval platform to understand the whole production track record. Therefore, production defect and abnormality report and track record retrieval system for the textile industry disclosed in the present utility model can significantly enhance management efficiency, reduce defect rate and enable quick retrieval and transparency of the production track record.

### BRIEF DESCRIPTION OF THE DRAWINGS

FIG. 1: Schematic view of the production defect and abnormality report and track record retrieval system for the textile industry according to the invention.

FIG. 2: flow chart of the production defect and abnormality report and track record retrieval system for the textile industry according to the invention.

### DETAILED DESCRIPTION OF THE INVENTION

For better understanding of the objects, technical solution, and advantages of the present utility model, detailed descriptions are provided below with reference to a preferred embodiment. However, the invention is not limited to the embodiment disclosed. Various equivalents or modifications can be made based on common technical knowledge and means by those skilled in the art without departing from the spirit of the present utility model. All such equivalents or modifications shall fall within the scope of the present utility model.

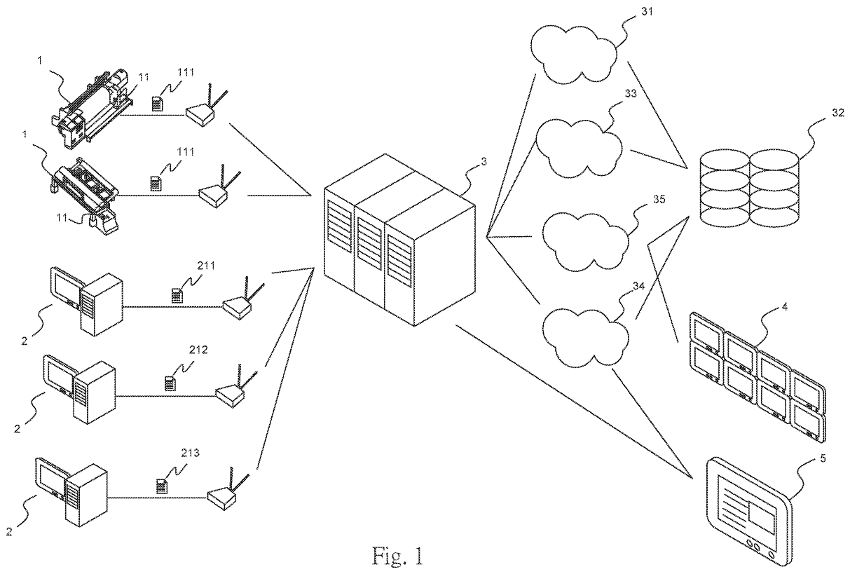

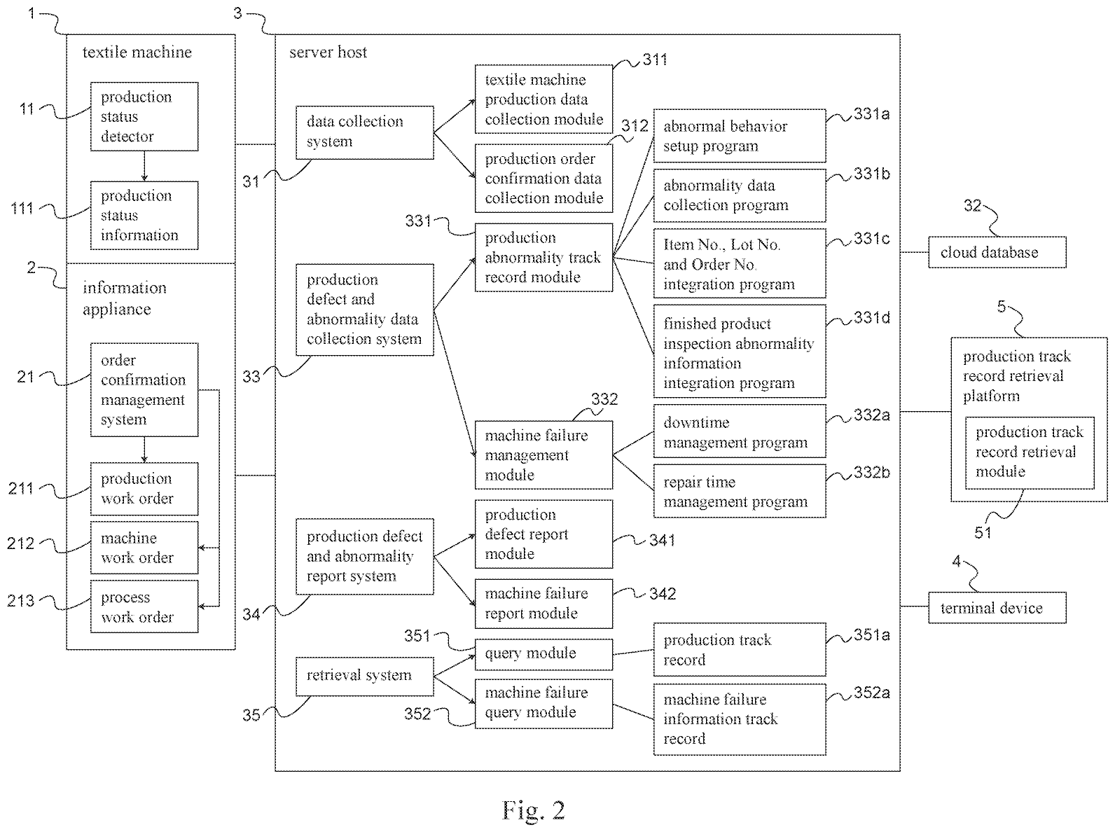

Disclosed in the present utility model is a “production defect and abnormality report and track record retrieval system for the textile industry”. FIGS. 1 and 2 are a schematic view and a flow chart of a production defect and abnormality report and track record retrieval system for the textile industry according to the present utility model. The production defect and abnormality report and track record retrieval system for the textile industry according to the present utility model comprises a textile machine (1), an information appliance (2), a server host (3) and a production track record retrieval platform (5); wherein, the textile machine (1) is equipped with at least one production status detector (11), the production status detector (11) can detect the production status information (111) of the textile machine (1); the information appliance (2) includes an order confirmation management system (21) for real-time input and generation of production work order (211), machine work order (212) and process work order (213); the server host (3) includes a data collection system (31), a cloud database (32), a production defect and abnormality data collection system (33), a production defect and abnormality report system (34) and a production track record (351a) retrieval system (35), wherein, the data collection system (31) includes a textile machine production data collection module (311) and a production order confirmation data collection module (312), the textile machine production data collection module (311) is connected to the textile machine (1), so that the production status information (111) of the textile machine (1) can be processed by the textile machine production data collection module (311) and be transmitted to the cloud database (32), the production order confirmation data module is connected to the information system, so that the production work order (211) and process work order (213) in the information system can be processed by the production order confirmation data module and transmitted to the cloud database (32); the production defect and abnormality data collection system (33) is connected to the cloud database (32), and includes a production abnormality track record module (331) and machine failure management module (332), the production abnormality track record module (331) is mainly used for collecting production abnormality data, and includes an abnormal behavior setup program (331a), an abnormality data collection program (331b), an Item No., Lot No. and Order No. integration program (331c) and a finished product inspection abnormality information integration program (331d), the machine failure management module (332) is mainly used for collecting machine failure data, and includes a downtime management program (332a) and a repair time management program (332b); the production defect and abnormality report system (34) is connected to the cloud server and includes a production defect report module (341) and a machine failure report module (342). After the production abnormality track record module (331) has collected the production abnormality data, the data will undergo intelligent computing by the production defect report module (341) and be transmitted to a terminal device (4); After the machine failure management module (332) has collected the machine failure data, the data will undergo intelligent computing by the machine failure report module (342) and be transmitted to a terminal device (4); the production track record (351a) retrieval system (35) is connected to the cloud server and includes a production track record (351a) query module (351) and a machine failure query module (352), the production track record (351a) query module (351) integrates the data from the textile machine production data collection module (311) and the production abnormality track record module (331) and generates a production track record (351a); the machine failure query module (352) integrates the data from the production order confirmation data collection module (312) and the machine failure management module (332) and generates a machine failure information track record (352a); the production track record retrieval platform (5) is connected to the server host (3), and includes a production track record retrieval module (51). The user can use the production track record retrieval module (51) to input Item No., Lot No., Color, Process, Defect Type or Order No. to the cloud database (32) to retrieve the production track record (351a) and the machine failure information track record (352a).

FIG. 2 is a flow chart of the production defect and abnormality report and track record retrieval system for the textile industry according to the present utility model. After the textile machine (1) has started production, the production status detector (11) will be started to detect the production status information (111) of the textile machine (1). The captured data will be processed by the textile machine production data collection module (311) of the data collection system (31) connected to the server host (3), and be transmitted to the cloud database (32); meanwhile, data can be input to the order confirmation management system (21) of the information appliance (2) to generate production work order (211), machine work order (212) and process work order (213). They will be processed by the production order confirmation data module of the data collection system (31) connected to the server host (3) and be transmitted to the cloud database (32). The production defect and abnormality data collection system (33) is connected to the cloud database (32) and includes a production abnormality track record module (331) and machine failure management module (332). The production abnormality track record module (331) is mainly used for collecting production abnormality data. The production status information (111) in the cloud database (32) obtained from the abnormal behavior setup program (331a), the abnormality data collection program (331b), the Item No., Lot No. and Order No. integration program (331c), and the finished product inspection abnormality information integration program (331d) will undergo intelligent computing by the production defect report module (341) and be transmitted to a terminal device (4); the machine failure management module (332) is mainly used for collecting machine failure data, and can combine the production status information (111) in the cloud database (32) with the production work order (211), machine work order (212) and process work order (213) for overall computing. They can be obtained from the downtime management program (332a) and the repair time management program (332b). After intelligent computing by the machine failure report module (342), they will be transmitted to a terminal device (4). The production track record (351a) retrieval system (35) is connected to the cloud server and includes a production track record (351a) query module (351) and a machine failure query module (352). The production track record (351a) query module (351) integrates data from the textile machine production data collection module (311) and the production abnormality track record module (331) and generates a production track record (351a). The machine failure query module (352) integrates data from the production order confirmation data collection module (312) and the machine failure management module (332) and generates a machine failure information track record (352a). Then, when the consumer, customer or management personnel is connected to the production track record retrieval platform (5) on the server host (3) to review the production track record (351a) or the production defect and abnormality information, Item No., Lot No., Color, Process, Defect Type or Order No. can be input, and the cloud database (32) can be accessed through the production track record retrieval module (51) for query of the production track record (351a) and the machine failure information track record (352a).

Although the invention has been explained in relation to its preferred embodiment, it is to be understood that many other possible modifications and variations can be made without departing from the spirit and scope of the invention as hereinafter claimed.

The embodiment of the present utility model can truly realize the expected efficacy. The detailed structure disclosed in the invention has never been seen in other similar products, and has never been disclosed before this patent application. Therefore, the provisions and requirements stipulated in the Patent Law are met, and an application for utility model is submitted herein. Your audit and approval will be highly appreciated.

1. A production defect and abnormality report and track record retrieval system for the textile industry, which comprises:
a textile machine, equipped with at least one production status detector, said production status detector can detect the production status information of the textile machine;
an information appliance, which includes an order confirmation management system, for real-time input and generation of production work orders, machine work orders and process work orders;
a server host, which includes a data collection system, a cloud database, a production defect and abnormality data collection system, a production defect and abnormality report system and a production track record retrieval system, wherein, the data collection system includes a textile machine production data collection module and a production order confirmation data collection module, the textile machine production data collection module is connected to the textile machine, so that the production status information of the textile machine can be processed by the textile machine production data collection module and transmitted to the cloud database, the production order confirmation data module is connected to the information system, so that the production work orders and process work orders in the information system can be processed by the production order confirmation data module and transmitted to the cloud database; the production defect and abnormality data collection system is connected to the cloud database, and includes a production abnormality track record module and a machine failure management module; the production abnormality track record module is mainly used for collecting production abnormality data, and includes an abnormal behavior setup program, an abnormality data collection program, an Item No., Lot No. and Order No. integration program and a finished product inspection abnormality information integration program, the machine failure management module is mainly used for collecting machine failure data, and includes a downtime management program and a repair time management program, the production defect and abnormality report system is connected to the cloud server and includes a production defect report module and a machine failure report module; after the production abnormality track record module has collected the production abnormality data, the data will undergo intelligent computing by the production defect report module and be transmitted to a terminal device; after the machine failure management module has collected the machine failure data, the data will undergo intelligent computing by the machine failure report module and be transmitted to a terminal device; the production track record retrieval system is connected to the cloud server and includes a production track record query module and a machine failure query module the production track record query module integrates the data from the textile machine production data collection module and production abnormality track record module and generates a production track record; the machine failure query module integrates the data from the production order confirmation data collection module and machine failure management module and generates a machine failure information track record;
a production track record retrieval platform, which is connected to the server host, and which includes a production track record retrieval module; the user can use the production track record retrieval module to input Item No., Lot No., Color, Process, Defect Type or Order No. to the cloud database and retrieve the production track record and machine failure information track record.
